(19) United States
(12) Patent Application Publication
(10) Pub. No.: US 2006/0202743 A1
(43) Pub. Date: Sep. 14, 2006

(54) Adaptive input voltage controlled voltage booster

(75) Inventor: Kyu-young Chung, Songpa-gu (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/354,462

(22) Filed: Feb. 15, 2006

(30) Foreign Application Priority Data
Mar. 14, 2005 (KR) 10-2005-0021093

(51) Int. Cl. G05F 1/10

(52) U.S. Cl. 327/536

(57) ABSTRACT

Provided is a voltage booster adaptively controlled by an input voltage. The voltage booster includes an Operational Transconductance Amplifier (OTA) having positive and negative input terminals and generating an output current in response to a voltage difference between the positive and negative input terminals. The positive input terminal of the OTA receives a voltage obtained by dividing a target output voltage of the voltage booster by n, and the negative input terminal of the OTA receives a voltage obtained by dividing an output voltage of the voltage booster by n. The output current of the OTA charges an input capacitor to generate a first input voltage. A buffer receives the first input voltage and outputs a second input voltage. The second input voltage is input to a voltage boosting unit to generate the output voltage having a voltage equal to n times the second input voltage, where n≧1.

### CROSS-REFERENCE TO RELATED PATENT APPLICATION

This application claims priority to Korean Patent Application No. 10-2005-0021093, filed on Mar. 14, 2005, the disclosure of which is herein incorporated by reference in its entirety.

### BACKGROUND OF THE INVENTION

1. Technical Field

The present invention relates to a semiconductor integrated circuit and, more particularly, to a voltage booster adaptively controlled by an input voltage and a voltage boosting method thereof.

2. Description of the Related Art

FIG. 1 is a circuit diagram of a conventional voltage booster 100 using a charge pump. Referring to FIG. 1, the voltage booster 100 includes first, second, third and fourth switches 102, 106, 108 and 110, and first and second capacitors 104 and 112. The first and third switches 102 and 108 are turned on in response to a first control signal P1, and the second and fourth switches 106 and 110 are turned on in response to a second control signal P2. The first and second control signals P1 and P2 are pulse signals of opposite phase, as shown in FIG. 2. The first capacitor 104 is charged by a received input voltage VIN during a logic high period of the first control signal P1. Subsequently, the second capacitor 112 is charged in response to the voltage charged in the first capacitor 104 during a logic high period of the second control signal P2. The output voltage VOUT charged in the second capacitor 112 has a voltage 2VIN of twice the input voltage VIN. The output voltage VOUT may be used to drive circuits drawing load current I_{L}.

FIG. 3 shows schematically the presence of parasitic resistance in the voltage booster 100 of FIG. 1. Referring to FIG. 3, the voltage booster 100 has a contact resistance Rin of an input terminal, and the input terminal receives the input voltage VIN from an external device. The first capacitor 104 has contact resistance Rs1 and Rs2 at both ends because it is used as an external device. The second capacitor 112 has a contact resistance R_{L} with respect to the output voltage VOUT because it is also used as an external device. These parasitic resistance Rin, Rs and R_{L} reduce the output voltage VOUT. The output voltage drop Vdeg caused by the parasitic resistance Rin, Rs and R_{L} is expressed as follows.
Vdeg=2RinI_{L} +4RsI_{L} +0.5R_{L} I_{L} [Equation 1]

The output voltage drop caused by the load current I_{L} is expressed as follows.

$$Vdeg = \frac{{I}_{L}}{{C}_{s} \cdot f} \qquad [ Equation 2 ]$$

The output voltage VOUT is obtained by subtracting the output voltage drops due to the parasitic resistance Rin, Rs and R_{L} and the load current I_{L} from the target voltage 2VIN, which is twice the input voltage VIN.

$$VOUT = 2 VIN - 2 {RinI}_{L} + 4 {RsI}_{L} + 0.5 {R}_{L} {I}_{L} - \frac{{I}_{L}}{Cs \cdot f} \qquad [ Equation 3 ]$$

Therefore, the voltage booster 100 has a reduced output voltage VOUT due to the parasitic resistance Rin, Rs and R_{L} and the load current I_{L} There is a need for a voltage booster that can boost the output voltage, for example, to twice the input voltage, or a multiple (×n) of the input voltage, without the voltage drop due to parasitic resistance and load current.

### SUMMARY OF THE INVENTION

Exemplary embodiments of the present invention provide a voltage booster adaptively controlled by an input voltage to boost the input voltage to a multiple (×n) of the input voltage.

According to an exemplary embodiment of the present invention, there is provided a voltage booster including an Operational Transconductance Amplifier (OTA), an input capacitor, a buffer, and a voltage boosting unit. The OTA has positive and negative input terminals and generates an output current in response to a voltage difference between the positive and negative input terminals. The positive input terminal receives a voltage obtained by dividing a target output voltage of the voltage booster by n, and the negative input terminal receives a voltage obtained by dividing an output voltage of the voltage booster by n. The input capacitor is charged by the output current of the OTA to generate a first input voltage. The buffer receives the first input voltage and outputs a second input voltage. The voltage boosting unit boosts the second input voltage to n times the second input voltage to generate the output voltage, where n≧1.

According to another exemplary embodiment of the present invention, there is provided a voltage booster including an OTA, an input capacitor, a buffer, and a voltage boosting unit. The OTA has positive and negative input terminals and generates an output current in response to a voltage difference between the positive and negative input terminals. The positive input terminal receives a voltage obtained by dividing a voltage, which is obtained by subtracting a target output voltage of the voltage booster from an output voltage of the voltage booster, by n+1, and the negative input terminal receives a ground voltage. The input capacitor is charged by the output current of the OTA to generate a first input voltage. The buffer receives the first input voltage and outputs a second input voltage. The voltage boosting unit boosts the second input voltage to n times the second input voltage to generate the output voltage, where n≧1.

### BRIEF DESCRIPTION OF THE DRAWINGS

The present invention will become more apparent to those of ordinary skill in the art when descriptions of exemplary embodiments thereof are read with reference to the accompanying drawings.

FIG. 1 is a circuit diagram of a conventional voltage booster using a charge pump.

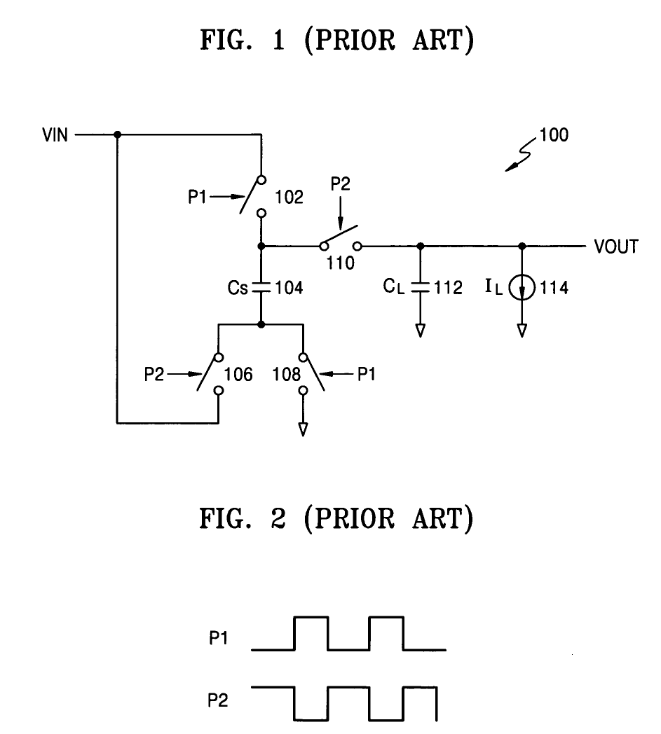

FIG. 2 is a diagram illustrating the waveforms of first and second control signals used in the voltage booster of FIG. 1.

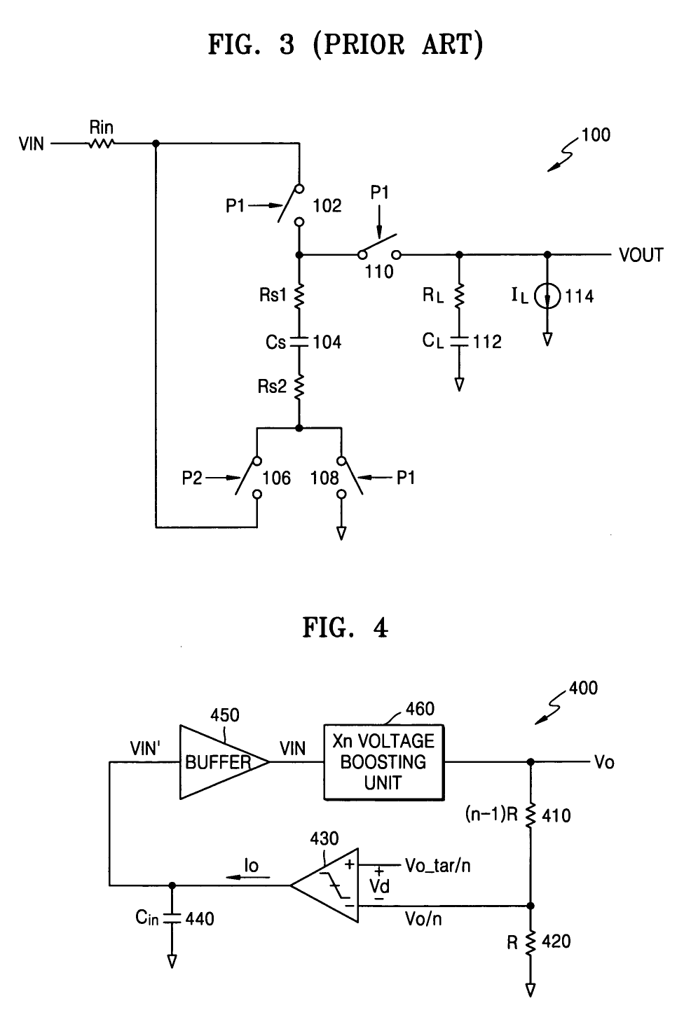

FIG. 3 shows schematically the presence of parasitic resistance in the voltage booster of FIG. 1.

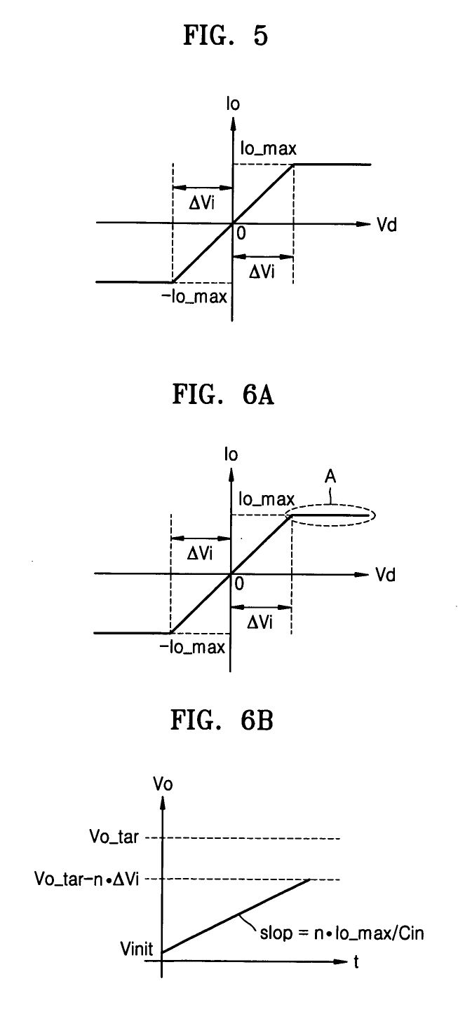

FIG. 4 is a diagram illustrating a positive voltage booster according to an exemplary embodiment of the present invention.

FIG. 5 is a graph showing the characteristics of the Operational Transconductance Amplifier (OTA) of FIG. 4.

FIGS. 6 through 9 are graphs for explaining the operation of the voltage booster of FIG. 4 by regions of the OTA characteristic graph of FIG. 5.

FIG. 10 is a graph for explaining the operation of the positive voltage booster of FIG. 4.

FIG. 11 is a diagram illustrating a negative voltage booster according to another exemplary embodiment of the present invention.

FIGS. 12 through 15 are OTA graphs for explaining the operation of the voltage booster of FIG. 11.

FIG. 16 is a graph for explaining the operation of the negative voltage booster of FIG. 11.

### DETAILED DESCRIPTION OF THE EXEMPLARY EMBODIMENTS

Hereinafter, the exemplary embodiments of the present invention will be described in detail with reference to the accompanying drawings. Like reference numerals refer to similar or identical elements throughout the description of the figures.

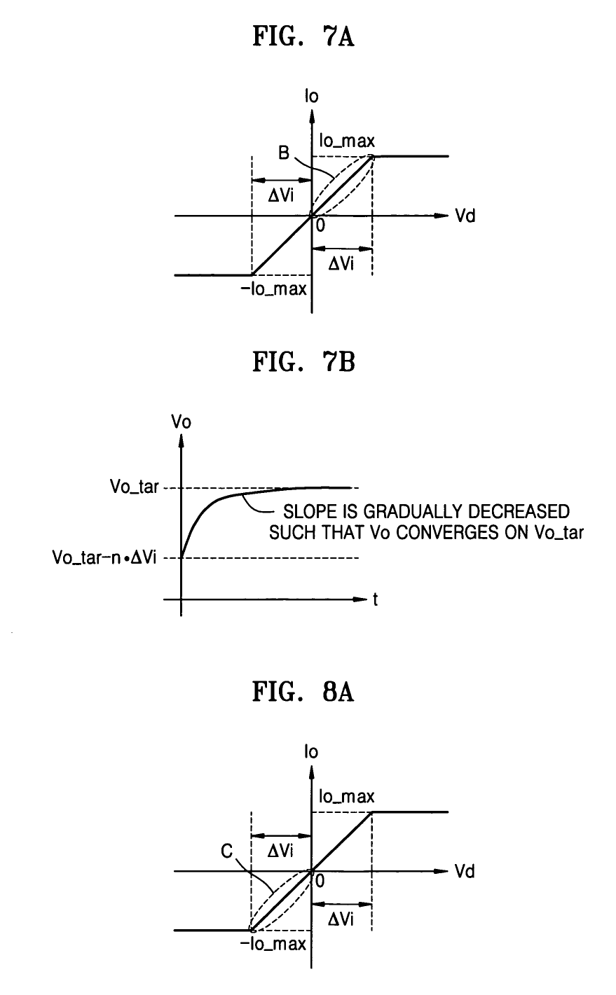

FIG. 4 is a diagram illustrating a positive voltage booster 400 according to an exemplary embodiment of the present invention. Referring to FIG. 4, the voltage booster 400 includes first and second resistors 410 and 420, an Operational Transconductance Amplifier (OTA) 430, an input capacitor 440, a buffer 450, and an n times voltage boosting unit 460, where n≧1. The first and second resistors 410 and 420 are connected in series between an output voltage Vo and a ground voltage. The first resistor 410 has a resistance of (n−1)R, where R is a reference resistance, and the second resistor 420 has a resistance of R. A voltage Vo/n obtained by dividing the output voltage Vo by n is applied to a node between the first and second resistors 410 and 420, where n>1. In another exemplary embodiment of the present invention, OTA 430 may be embodied where n>2.

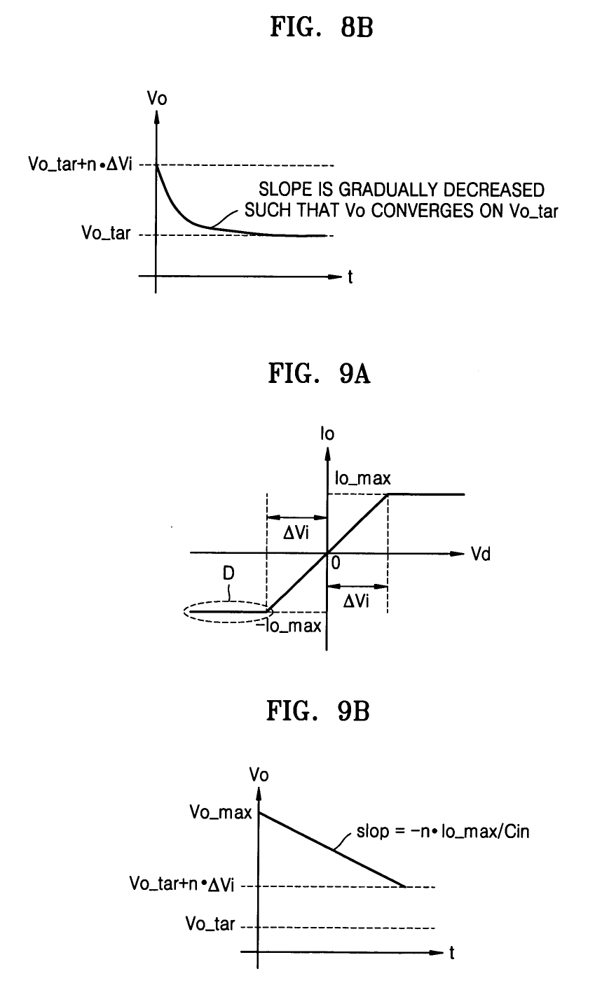

The output current lo of the OTA 430 varies depending on the voltage difference Vd between the voltages respectively input to positive (+) and negative (−) input terminals of the OTA 430. FIG. 5 is a graph showing the characteristics of the OTA 430 of FIG. 4. Referring to FIG. 5, the output current lo has linear characteristics such that it is proportional to the voltage difference Vd when the voltage difference Vd is within the range ΔVi. The output current lo has saturation characteristics such that it reaches a maximum output current Io_max irrespective of the voltage difference Vd, when the voltage difference Vd is outside the range ΔVi. The positive input terminal of the OTA 430 is provided with a voltage Vo_tar/n obtained by dividing a target output voltage Vo_tar of the voltage booster 400 by n, and the negative input terminal of the OTA 430 is provided with the voltage Vo/n obtained by dividing the output voltage Vo of the voltage booster by n, where n≧1. In another exemplary embodiment of the present invention, positive voltage booster 400 may be embodied where n≧2.

The output current lo of the OTA 430 charges the input capacitor 440 to generate a first input voltage VIN′. The first input voltage VIN′ becomes a second input voltage VIN through the buffer 450. The buffer 450 comprises an analog buffer providing approximately unity gain such that the first input voltage VIN′ and the second input voltage VIN are the same or approximately the same. The second input voltage VIN may have a large current driving capability according to the characteristics of the analog buffer. The n times voltage boosting unit 460 receives the second input voltage VIN to generate the positive output voltage Vo having a voltage n×VIN corresponding to n times the second input voltage VIN.

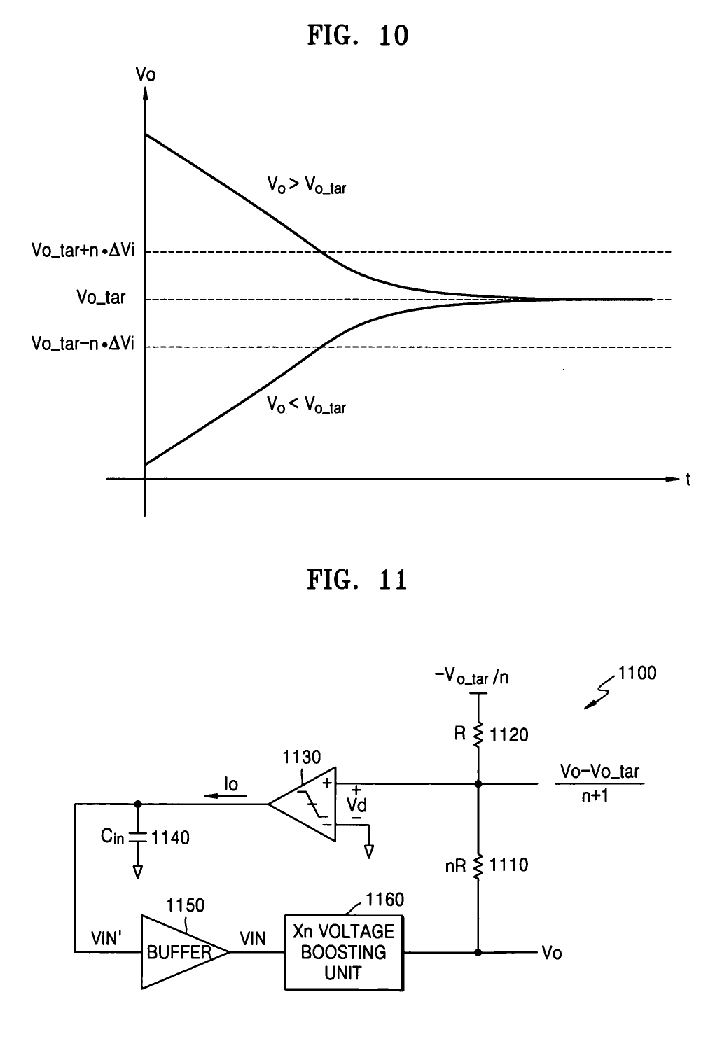

FIGS. 6, 7, 8 and 9 are graphs for explaining the operation of the voltage booster of FIG. 4 by regions of the OTA characteristic graph of FIG. 5.

Firstly, when the output voltage Vo of the voltage booster 400 is lower than a voltage Vo_tar−n·ΔVi obtained by subtracting n times the voltage range, n·ΔVi, from a target voltage Vo_tar, the output voltage Vo is expressed as follows.
Vₒ₋ₜₐᵣ−n·ΔVi>Vo [Equation 4 ]
Vₒ₋ₜₐᵣ/n−ΔVi>VoIn [Equation 5]
Vd=Vₒ₋ₜₐᵣ/n−VoIn>ΔVi [Equation 6]

Accordingly, the input voltage difference Vd of the OTA 430 is in a region A outside the positive voltage range ΔVi shown in FIG. 6A, and thus the output current lo of the OTA 430 becomes the maximum output current Io_max. The first and second input voltages VIN′ and VIN have an increase of Io_max/Cin obtained by dividing the maximum output current Io_max, by the capacitance Cin of the input capacitor 440. Accordingly, the output voltage Vo of the voltage boosting unit 460 has a slope corresponding to n·Io_max/Cin, and ranges from an initial output voltage Vinit to the voltage Vo_tar-n·ΔVi, as shown in FIG. 6B. When the output voltage Vo is lower than the target voltage Vo_tar, the capacitance Cin of the input capacitor 440 can be controlled such that the first and second input voltages VIN′ and VIN can be rapidly increased to rapidly raise the output voltage Vo.

Secondly, when the output voltage Vo of the voltage booster 400 is higher than the voltage Vo_tar−n·ΔVi, but lower than the target voltage Vo-tar, the output voltage Vo is expressed as follows.
Vₒ₋ₜₐᵣ−n·ΔVi<Vo<Vₒ₋ₜₐᵣ [Equation 7]
Vₒ₋ₜₐᵣIn−ΔVi<VoIn<Vₒ₋ₜₐᵣ In [Equation 8]
0≦Vd=Vₒ₋ₜₐᵣIn−VoIn<ΔVi [Equation 9]

Accordingly, the input voltage difference Vd of the OTA 430 is in a region B within the positive voltage range ΔVi shown in FIG. 7A, and thus the output current Io of the OTA 430 ranges between 0 and the maximum output current Io_max. The second input voltage VIN input to the voltage boosting unit 460 is increased with an increase of Io/Cin obtained by dividing the output current lo by the capacitance Cin of the input capacitor 440. Accordingly, the output voltage Vo of the voltage boosting unit 460 is increased to the target voltage Vo_tar. However, the input voltage difference Vd of the OTA 430 is decreased as the output voltage Vo approaches the target voltage Vo_tar, and thus increases of the first and second input voltages VIN′ and VIN and the output voltage Vo are smaller. Therefore, the slope n·Io/Cin of the output voltage Vo is gradually decreased such that the output voltage Vo smoothly converges on the target voltage Vo_tar, as shown in FIG. 7B.

Thirdly, when the output voltage Vo of the voltage booster 400 is higher than the target voltage Vo_tar, but lower than a voltage Vo_tar+n·ΔVi obtained by adding n times the voltage range, n·ΔVi, to the target voltage Vo_tar, the output voltage Vo is expressed as follows.
Vₒ₋ₜₐᵣ<Vo<Vₒ₋ₜₐᵣ+n·ΔVi [Equation 10]
Vₒ₋ₜₐᵣIn<VoIn<Vₒ₋ₜₐᵣIn+ΔVi [Equation 11]
−ΔVi≦Vd=Vₒ₋ₜₐᵣIn−VoIn<0 [Equation 12]

Accordingly, the input voltage difference Vd of the OTA 430 is in a region C within the negative voltage range ΔVi shown in FIG. 8A, and thus the output current Io of the OTA 430 ranges between a negative maximum output current −I_max and 0. The second input voltage VIN input to the voltage boosting unit 460 is decreased with a slope of Io/Cin obtained by dividing the output current Io by the capacitance Cin of the input capacitor 440. Accordingly, the output voltage Vo of the voltage boosting unit 460 is decreased to the target voltage Vo_tar. However, the input voltage difference Vd of the OTA 430 is decreased as the output voltage Vo approaches the target voltage Vo_tar, and thus increases of the first and second input voltages VIN′ and VIN and the output voltage Vo are smaller. Therefore, the slope −n·Io/Cin of the output voltage Vo is gradually decreased such that the output voltage Vo smoothly converges on the target voltage Vo_tar, as shown in FIG. 8B. When the output voltage Vo is slightly higher than the target voltage Vo_tar, decreases of the first and second input voltages VIN′ and VIN are smaller as the difference between the output voltage Vo and the target voltage Vo_tar becomes small, to minimize ripple near the target voltage Vo_tar.

Fourthly, when the output voltage Vo of the voltage booster 400 is higher than the voltage Vo_tar+n·ΔVi obtained by adding n times the voltage range, n·ΔVi, to the target voltage Vo_tar, the output voltage Vo is expressed as follows.
Vₒ₋ₜₐᵣ+n·ΔVi<Vo [Equation 12]
Vₒ₋ₜₐᵣ/n+ΔVi<Vo/n [Equation 14]
Vd=Vₒ₋ₜₐᵣ/n−Vo/n<−ΔVi [Equation 15]

Accordingly, the input voltage difference Vd of the OTA 430 is in a region D outside the negative voltage range ΔVi shown in FIG. 9A, and thus the output current lo of the OTA 430 reaches a negative maximum output current Io_max. The first and second input voltages VIN′ and VIN have a decrease of −Io_max/Cin obtained by dividing the negative maximum output current −Io_max, by the capacitance Cin of the input capacitor 440. Accordingly, the output voltage Vo of the voltage boosting unit 460 has a slope corresponding to −n·Io_max/Cin and ranges from the maximum output voltage Vo_max to the voltage Vo_tar+n·ΔVi, as shown in FIG. 9B. When the output voltage Vo is higher than the target voltage Vo_tar, the capacitance Cin of the input capacitor 440 can be controlled such that the first and second input voltages VIN′ and VIN can be increased rapidly, to rapidly raise the output voltage Vo.

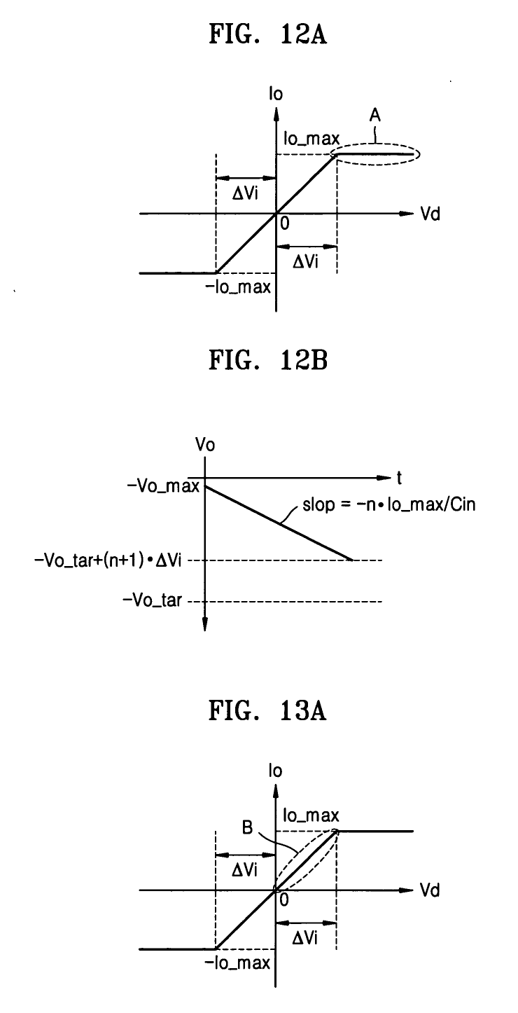

The graphs shown in FIGS. 6, 7, 8 and 9 are integrated into the graph shown in FIG. 10.

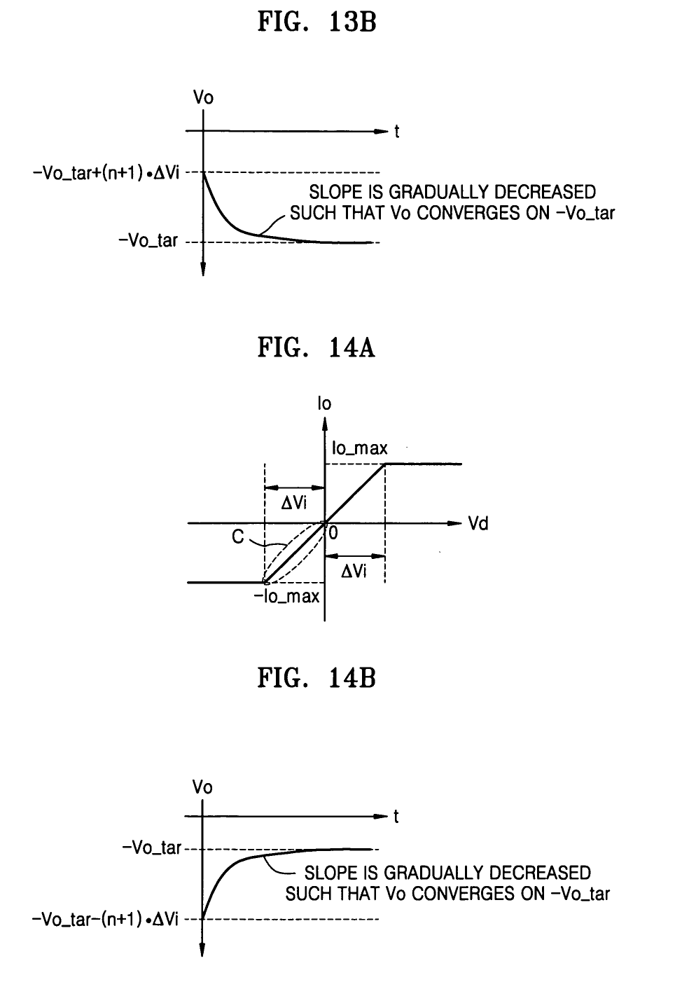

FIG. 11 is a diagram illustrating a negative voltage booster 1100 according to another exemplary embodiment of the present invention. Referring to FIG. 11, the voltage booster 1100 includes first and second resistors 1110 and 1120 connected in series between an output voltage Vo and 1/n times a target voltage −Vo_tar, an OTA 1130 receiving the voltage at a node between the first and second resistors 1110 and 1120 and a ground voltage, an input capacitor 1140 charged by the output current Io of the OTA 1130, a buffer 1150 receiving a first input voltage VIN′ charged in the input capacitor 1140 to generate a second input voltage VIN, and an n times voltage boosting unit 1160 receiving the second input voltage VIN and boosting the received second input voltage to n times the second input voltage to generate a negative output voltage Vo, where n>1. In another exemplary embodiment of the present invention, negative voltage booster 1100 may be embodied where n≧2.

The first resistor 1110 has a resistance of nR, where R is a reference resistance, and the second resistor 1120 has the reference resistance R. Accordingly, the voltage of the node between the first and second resistors 1110 and 1120 corresponds to (Vo−Vo_tar)/n+1. The output current lo of the OTA varies depending on the difference Vd between the voltages respectively applied to positive and negative input terminals of the OTA 1130. The OTA 1130 has linear characteristics such that its output current Io is proportional to the voltage difference Vd when the voltage difference Vd is within a voltage range ΔVi. The OTA 1130 has saturation characteristics such that its output current Io reaches a maximum output current Io_max irrespective of the voltage difference Vd when the voltage difference Vd is outside the voltage range ΔVi. The node voltage (Vo−Vo_tar)/(n+1) between the first and second resistors 1110 and 1120 is applied to the positive input terminal of the OTA 1130, and a ground voltage is applied to the negative input terminal.

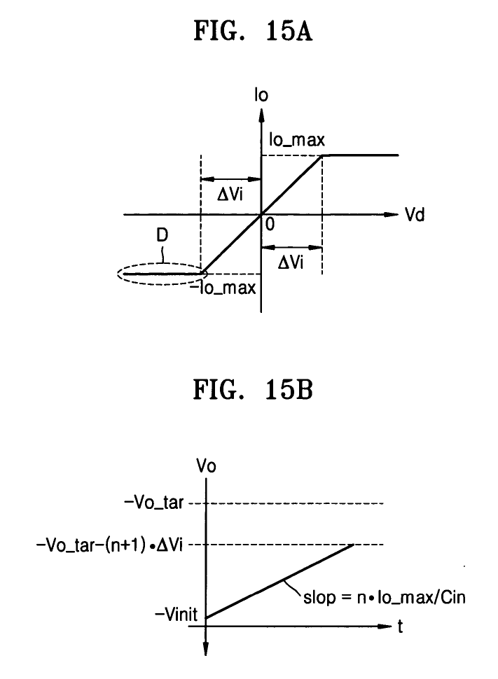

FIGS. 12, 13, 14, and 15 are OTA graphs for explaining the operation of the voltage booster of FIG. 11.

Firstly, when the output voltage Vo of the negative voltage booster 1100 is higher than a voltage −Vo_tar+(n+1)·ΔVi obtained by adding (n+1) times the voltage range ΔVi to the target voltage −Vo_tar, the output voltage Vo is expressed as follows.
Vₒ₋ₜₐᵣ+(n+1)·ΔVi>Vo [Equation 16]
Vₒ₋ₜₐᵣ/(n+1)+ΔVi>Vo/(n+1) [Equation 17]
Vd=(Vₒ₋ₜₐᵣ−Vo)/(n+1)>ΔVi [Equation 16]

Accordingly, the input voltage difference Vd of the OTA 1130 is in a region A outside the positive voltage range ΔVi shown in FIG. 12A, and thus the output current Io of the OTA 1130 becomes the maximum output current Io_max. The first and second input voltages VIN′ and VIN have a decrease of Io_max/Cin obtained by dividing the maximum output current Io_max, by the capacitance Cin of the input capacitor 1140. Accordingly, the output voltage Vo of the voltage boosting unit 1160 has a negative slope corresponding to −n·Io_max/Cin and ranges from a negative maximum output voltage −Vo_max to the voltage −Vo_tar+(n+1)·ΔVi, as shown in FIG. 12B. When the output voltage Vo is higher than the negative target voltage −Vo_tar, the capacitance Cin of the input capacitor 1140 can be controlled such that the first and second input voltages VIN′ and VIN can be rapidly decreased to rapidly reduce the output voltage Vo.

Secondly, when the output voltage Vo of the voltage booster 1100 is lower than the voltage −Vo_tar+(n+1)·ΔVi, but higher than the target voltage −Vo_tar, the output voltage Vo is expressed as follows.
Vₒ₋ₜₐᵣ<Vo<Vₒ₋ₜₐᵣ+(n+1)·ΔVi [Equation 19]
Vₒ₋ₜₐᵣ/(n+1)<Vo/(n+1)<Vₒ₋ₜₐᵣ/(n+1)+ΔVi [Equation 20]
0≦Vd=(Vₒ₋ₜₐᵣ−Vo)/(n+1)<ΔVi [Equation 21]

Accordingly, the input voltage difference Vd of the OTA 1130 is in a region B within the positive voltage range ΔVi shown in FIG. 13A, and thus the output current Io of the OTA 1130 ranges between 0 and the maximum output current Io_max. The second input voltage VIN input to the voltage boosting unit 1160 is reduced with a slope of Io/Cin obtained by dividing the output current Io by the capacitance Cin of the input capacitor 1140. Accordingly, the output voltage Vo of the voltage boosting unit 1160 is decreased to the target voltage −Vo_tar. However, the input voltage difference Vd of the OTA 1130 is decreased as the output voltage Vo approaches the target voltage −Vo_tar, and thus decreases of the first and second input voltages VIN′ and VIN and the output voltage Vo are smaller. Therefore, the slope −n·Io/Cin of the output voltage Vo is gradually decreased such that the output voltage Vo smoothly converges on the target voltage −Vo_tar, as shown in FIG. 13B.

Thirdly, when the output voltage Vo of the voltage booster 1100 is higher than a voltage −Vo_tar−(n+1)·ΔVi obtained by subtracting (n+1) times the voltage range, (n+1)·ΔVi, from the target voltage −Vo_tar, but lower than the target voltage −Vo_tar, the output voltage Vo is expressed as follows.
Vₒ₋ₜₐᵣ−(n+1)·ΔVi<Vo<Vₒ₋ₜₐᵣ [Equation 22]
Vₒ₋ₜₐᵣ/(n+1)−ΔVi<Vo/(n+1)<Vₒ₋ₜₐᵣ/(n+1) [Equation 23]
−ΔVi≦Vd=(Vₒ₋ₜₐᵣ−Vo)/(n+1)< [Equation 24]

Accordingly, the input voltage difference Vd of the OTA 1130 is in a region C within the negative voltage range ΔVi shown in FIG. 14A, and thus the output current Io of the OTA 1130 ranges between a negative maximum output current −Io_max and 0. The second input voltage VIN input to the voltage boosting unit 1160 is increased with a slope Io/Cin obtained by dividing the output current lo by the capacitance Cin of the input capacitor 1140. Accordingly, the output voltage Vo of the voltage boosting unit 1160 is increased to the target voltage −Vo_tar. However, the input voltage difference Vd of the OTA 1130 is decreased as the output voltage Vo approaches the target voltage −Vo_tar, and thus increases of the first and second input voltages VIN′ and VIN and the output voltage Vo are smaller. Therefore, the slope of the output voltage Vo is gradually decreased such that the output voltage Vo smoothly converges on the target voltage −Vo_tar, as shown in FIG. 14B. Here, when the output voltage Vo is slightly lower than the target voltage −Vo_tar, increases of the first and second input voltages VIN′ and VIN are smaller as the difference between the output voltage Vo and the target voltage −Vo_tar becomes small, to minimize ripple near the target voltage −Vo_tar.

Fourthly, when the output voltage Vo of the voltage booster 1100 is lower than the voltage −Vo_tar−(n+1), ΔVi obtained by subtracting (n+1) times the voltage range, (n+1)·ΔVi, from the target voltage −Vo_tar, the output voltage Vo is expressed as follows.
Vo<Vₒ₋ₜₐᵣ−(n+1)·ΔVi [Equation 25]
Vo/(n+1)<Vₒ₋ₜₐᵣ/(n+1)−ΔV [Equation 26]
Vd=(Vₒ₋ₜₐᵣ−Vo)/(n+1)<−ΔVi [Equation 27]

Accordingly, the input voltage difference Vd of the OTA 1130 is in a region D outside the negative voltage range ΔVi shown in FIG. 15A, and thus the output current Io of the OTA 1130 becomes the negative maximum output current −Io_max. The first and second input voltages VIN′ and VIN have an increase of −Io_max/Cin obtained by dividing the negative maximum output current Io_max, by the capacitance Cin of the input capacitor 1140. Accordingly, the output voltage Vo of the voltage boosting unit 1160 has a positive slope corresponding to n·lo_max/Cin and ranges from a negative initial output voltage −Vinit to the voltage−Vo_tar−(n+1)·ΔVi, as shown in FIG. 15B. When the output voltage Vo is lower than the target voltage −Vo_tar, the capacitance Cin of the input capacitor 1140 can be controlled such that the first and second input voltages VIN′ and VIN can be rapidly increased to rapidly raise the output voltage Vo.

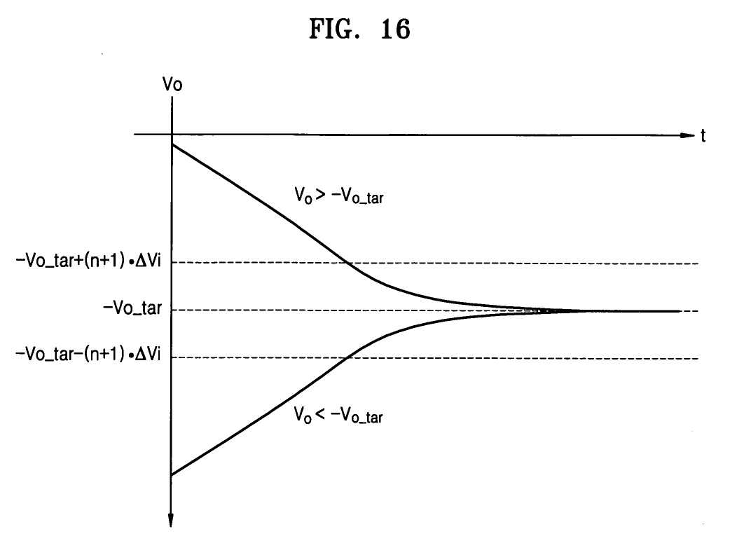

The graphs shown in FIGS. 12, 13, 14 and 15 are integrated into the graph shown in FIG. 16.

The positive voltage booster 400 and the negative voltage booster 1100 according to exemplary embodiments of the present invention generate stable target voltages without any drop due to parasitic resistance or load current.

Although the exemplary embodiments of the present invention have been described with reference to the accompanying drawings for the purpose of illustration, it is to be understood that the inventive processes and apparatus are not to be construed as limited thereby. It will be readily apparent to those of ordinary skill in the art that various modifications to the foregoing exemplary embodiments may be made without departing from the scope of the invention as defined by the appended claims, with equivalents of the claims to be included therein.

What is claimed is:

1. A positive voltage booster comprising:
an Operational Transconductance Amplifier (OTA) having positive and negative input terminals and generating an output current in response to a voltage difference between the positive and negative input terminals, the positive input terminal receiving a voltage obtained by dividing a target output voltage of the voltage booster by n, the negative input terminal receiving a voltage obtained by dividing an output voltage of the voltage booster by n;
an input capacitor charged by the output current of the OTA to generate a first input voltage;
a buffer receiving the first input voltage and outputting a second input voltage; and
a voltage boosting unit boosting the second input voltage to n times the second input voltage to generate the output voltage, where n≧1.

2. The positive voltage booster of claim 1, wherein the buffer outputs the second input voltage to be equal to the first input voltage, with a high current capability.

3. The positive voltage booster of claim 1, wherein the buffer comprises an analog buffer providing approximately unity gain.

4. The positive voltage booster of claim 1, wherein the voltage boosting unit comprises a charge pump that receives the second input voltage to generate the output voltage.

5. A positive voltage booster comprising:
first and second resistors connected in series between an output voltage of the voltage booster and a ground voltage;
an OTA having positive and negative input terminals and generating an output current in response to a voltage difference between the positive and negative input terminals, the positive input terminal receiving a voltage obtained by dividing a target output voltage of the voltage booster by n, the negative input terminal being connected to a node between the first and second resistors;
an input capacitor charged by the output current of the OTA to generate a first input voltage;
a buffer receiving the first input voltage and outputting a second input voltage; and
a voltage boosting unit boosting the second input voltage to n times the second input voltage to generate the output voltage, where n>1.

6. The positive voltage booster of claim 5, wherein the first resistor has a resistance of (n−1)R, where R is a reference resistance, and the second resistor has the reference resistance R.

7. The positive voltage booster of claim 5, wherein the buffer outputs the second input voltage to be equal to the first input voltage, with a high current capability.

8. The positive voltage booster of claim 5, wherein the buffer comprises an analog buffer providing approximately unity gain.

9. The positive voltage booster of claim 5, wherein the voltage boosting unit comprises a charge pump that receives the second input voltage to generate the output voltage.

10. A negative voltage booster comprising:
an OTA having positive and negative input terminals and generating an output current in response to a voltage difference between the positive and negative input terminals, the positive input terminal receiving a voltage obtained by dividing a voltage, which is obtained by subtracting a target output voltage of the voltage booster from an output voltage of the voltage booster, by n+1, the negative input terminal receiving a ground voltage;
an input capacitor charged by the output current of the OTA to generate a first input voltage;
a buffer receiving the first input voltage and outputting a second input voltage; and
a voltage boosting unit boosting the second input voltage to n times the second input voltage to generate the output voltage, where n≧1.

11. The negative voltage booster of claim 10, wherein the buffer outputs the second input voltage to be equal to the first input voltage.

12. The negative voltage booster of claim 10, wherein the buffer comprises an analog buffer providing approximately unity gain.

13. The negative voltage booster of claim 10, wherein the voltage boosting unit comprises a charge pump that receives the second input voltage to generate the output voltage.

14. The negative voltage booster of claim 10, where n>2.

15. A negative voltage booster comprising:
first and second resistors connected in series between an output voltage of the voltage booster and a voltage obtained by dividing a negative target output voltage of the voltage booster by n;
an OTA having positive and negative input terminals and generating an output current in response to a voltage difference between the positive and negative input terminals, the positive input terminal being connected to a node between the first and second resistors, and the negative input terminal receiving a ground voltage;
an input capacitor charged by the output current of the OTA to generate a first input voltage;
a buffer receiving the first input voltage and outputting a second input voltage; and
a voltage boosting unit boosting the second input voltage to n times the second input voltage to generate the output voltage, where n>1.

16. The negative voltage booster of claim 15, wherein the first resistor has a resistance of (n−1)R, where R is a reference resistance, and the second resistor has the reference resistance R.

17. The negative voltage booster of claim 15, wherein the buffer outputs the second input voltage to be equal to the first input voltage.

18. The negative voltage booster of claim 15, wherein the buffer comprises an analog buffer providing approximately unity gain.

19. The negative voltage booster of claim 15, wherein the voltage boosting unit comprises a charge pump that receives the second input voltage to generate the output voltage.

20. The negative voltage booster of claim 15, where n≧2.
